(19) United States
(12) Patent Application Publication
(10) Pub. No.: US 2023/0282906 A1
(43) Pub. Date: Sep. 7, 2023

(54) ELECTROCHEMICAL CELLS AND ELECTROCHEMICAL CELL SYSTEMS WITH THERMAL INSULATION BATTERY PACKS

(71) Applicant: 24M Technologies, Inc., Cambridge, MA (US)

(72) Inventors: Junzheng CHEN, Concord, MA (US); Naoki OTA, Lexington, MA (US); Ryan Michael LAWRENCE, Cambridge, MA (US); Jeffry DISKO, Lexington, MA (US); Chad Alan HARTZOG, Columbus, IN (US)

(21) Appl. No.: 18/118,416

(22) Filed: Mar. 7, 2023

Related U.S. Application Data
(60) Provisional application No. 63/317,254, filed on Mar. 7, 2022.

(51) Int. Cl. H01M 10/658; H01M 50/117; H01M 50/119; H01M 10/6563; H01M 10/48; H01M 10/6551; H01M 50/128

(52) U.S. Cl. CPC H01M 10/658; H01M 50/117; H01M 50/119; H01M 10/6563; H01M 10/486; H01M 10/6551; H01M 50/128

(57) ABSTRACT

Embodiments described herein relate to electrochemical cells and electrochemical cell systems with thermal insulation systems, and methods of producing the same. An electrochemical cell can include an anode material disposed on an anode current collector, a cathode material disposed on a cathode current collector, a separator disposed between the anode material and the cathode material, and an insulating structure disposed around and containing the anode material, anode current collector, cathode material, cathode current collector, and the separator. The anode material and/or the cathode material includes a semi-solid electrode material. The semi-solid electrode material includes an active material and a conductive material in a liquid electrolyte. The liquid electrolyte has an electrolyte salt concentration of at least about 2.0 M. In some embodiments, the insulating structure includes a frame with a first wall and a second wall disposed therein.

### CROSS REFERENCE TO RELATED APPLICATIONS

This application claims the benefit of U.S. Provisional Application No. 63/317,254, titled, “Electrochemical Cells and Electrochemical Cell Systems with Thermal Insulation Battery Packs,” and filed Mar. 7, 2022, the content of which is incorporated herein by reference in its entirety.

### TECHNICAL FIELD

Embodiments described herein relate to electrochemical cells and electrochemical cell systems with thermal insulation systems.

### BACKGROUND

Electrochemical cells often have a desired temperature or temperature range, at which cell performance and efficiency are at their highest. The specific range of this good performance can depend on the chemistry of the electrochemical cell, as well as several other factors. These other factors can include geometry, size, and relative concentrations of salt in the electrolyte, as well as amount of electroactive species in the electrodes. Preventing unwanted heat loss from electrochemical cells and electrochemical cell systems is an important step in maximizing cell efficiency.

### SUMMARY

Embodiments described herein relate to electrochemical cells and electrochemical cell systems with thermal insulation systems, and methods of producing the same. An electrochemical cell can include an anode material disposed on an anode current collector, a cathode material disposed on a cathode current collector, a separator disposed between the anode material and the cathode material, and an insulating structure disposed around and containing the anode material, anode current collector, cathode material, cathode current collector, and the separator. The anode material and/or the cathode material can include a semi-solid electrode material. The semi-solid electrode material includes an active material in a liquid electrolyte. In some embodiments, the semis-solid electrode material can include a conductive material. The liquid electrolyte has an electrolyte salt concentration of at least about 2.0 M. In some embodiments, the insulating structure includes a frame with a first wall and a second wall disposed therein. In some embodiments, at least a portion of the first wall and/or the second wall can include glass. In some embodiments, the region between the first wall and the second wall can be evacuated. In some embodiments, the region between the first wall and the second wall can be filled with an inert gas.

### BRIEF DESCRIPTION OF THE DRAWINGS

FIG. 1 is a block diagram of an electrochemical cell with a thermal insulation system, according to an embodiment.

FIG. 2 is an illustration of a thermal insulation system, according to an embodiment.

FIGS. 3A-3B is an illustration of a thermal insulation system, according to an embodiment.

FIG. 4 is an illustration of a thermal insulation system with a vent, according to an embodiment.

FIG. 5 is an illustration of an electrochemical cell module with a thermal insulation system, according to an embodiment.

FIG. 6 is an illustration of an electrochemical cell module with heat transfer fins, according to an embodiment.

FIGS. 7A-7B are illustrations of a heat transfer fin, according to an embodiment.

FIGS. 8A-8B are illustrations of a heat transfer fin, according to an embodiment.

FIG. 9 is an illustration of an electrochemical cell module with a thermal insulation system, according to an embodiment.

### DETAILED DESCRIPTION

Electrochemical cells with one or more semi-solid electrodes can have a wide range of salt concentrations in the electrolyte. Semi-solid electrodes with high salt concentrations (e.g., at least about 2 M) perform well at high temperatures, maintaining good capacity retention over many cycles (e.g., about 400 cycles or more). However, loss of heat or introduction of lower temperatures to such cells can be detrimental to performance and capacity retention. Insulating systems integrated into electrochemical cells and electrochemical cell systems can maintain electrochemical cells and electrochemical cell systems at high temperatures with little or no additional energy input. These systems can include several different designs, including a battery pack casing with first glass pane, a second glass pane, and a gap between the first glass pane and the second glass pane. In some embodiments, heat shielding material can be used to form an insulating battery pack.

In some embodiments, electrodes described herein can be semi-solid electrodes. In comparison to conventional electrodes, semi-solid electrodes can be made (i) thicker (e.g., greater than about 100 μm-up to about 2,000 μm or even greater) due to the reduced tortuosity and higher electronic conductivity of semi-solid electrodes, (ii) with higher loadings of active materials, (iii) with a simplified manufacturing process utilizing less equipment, and (iv) can be operated between a wide range of C-rates while maintaining a substantial portion of their theoretical charge capacity. These relatively thick semi-solid electrodes decrease the volume, mass and cost contributions of inactive components with respect to active components, thereby enhancing the commercial appeal of batteries made with the semi-solid electrodes. In some embodiments, the semi-solid electrodes described herein, are binderless and/or do not use binders that are used in conventional battery manufacturing. Instead, the volume of the electrode normally occupied by binders in conventional electrodes, is now occupied, by: 1) electrolyte, which has the effect of decreasing tortuosity and increasing the total salt available for ion diffusion, thereby countering the salt depletion effects typical of thick conventional electrodes when used at high rate, 2) active material, which has the effect of increasing the charge capacity of the battery, or 3) conductive additive, which has the effect of increasing the electronic conductivity of the electrode, thereby countering the high internal impedance of thick conventional electrodes. The reduced tortuosity and a higher electronic conductivity of the semi-solid electrodes described herein, results in superior rate capability and charge capacity of electrochemical cells formed from the semi-solid electrodes.

Since the semi-solid electrodes described herein can be made substantially thicker than conventional electrodes, the ratio of active materials (i.e., the semi-solid cathode and/or anode) to inactive materials (i.e., the current collector and separator) can be much higher in a battery formed from electrochemical cell stacks that include semi-solid electrodes relative to a similar battery formed form electrochemical cell stacks that include conventional electrodes. This substantially increases the overall charge capacity and energy density of a battery that includes the semi-solid electrodes described herein. The use of semi-solid, binderless electrodes can also be beneficial in the incorporation of an overcharge protection mechanism, as generated gas can migrate to the electrode/current collector interface without binder particles inhibiting the movement of the gas within the electrode.

In some embodiments, the electrode materials described herein can be a flowable semi-solid or condensed liquid composition. A flowable semi-solid electrode can include a suspension of an electrochemically active material (anodic or cathodic particles or particulates), and optionally an electronically conductive material (e.g., carbon) in a non-aqueous liquid electrolyte. Said another way, the active electrode particles and conductive particles are co-suspended in a liquid electrolyte to produce a semi-solid electrode. Examples of electrochemical cells that include a semi-solid and/or binderless electrode material are described in U.S. Pat. No. 8,993,159 entitled, “Semi-solid Electrodes Having High Rate Capability,” filed Apr. 29, 2013 (“the '159 patent”), the disclosure of which is incorporated herein by reference in its entirety.

In some embodiments, the electrode materials described herein can be a flowable semi-solid or condensed liquid composition. In some embodiments, a flowable semi-solid electrode can include a suspension of an electrochemically active material (anodic or cathodic particles or particulates), and optionally an electronically conductive material (e.g., carbon) in a non-aqueous liquid electrolyte. In some embodiments, the active electrode particles and conductive particles can be co-suspended in an electrolyte to produce a semi-solid electrode. In some embodiments, electrode materials described herein can include conventional electrode materials (e.g., including lithium metal).

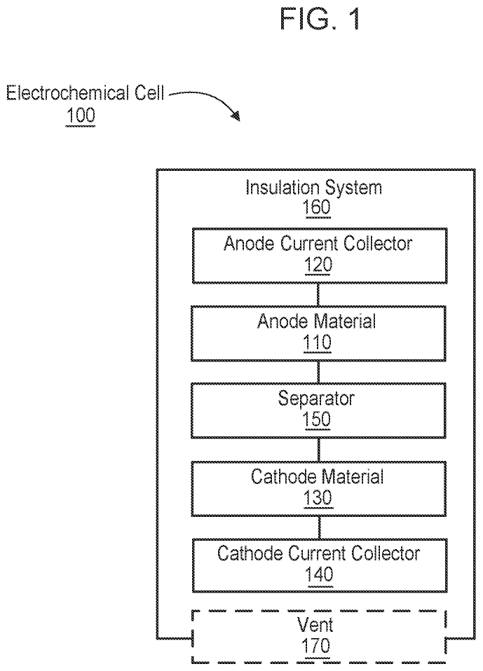

FIG. 1 is a block diagram of an electrochemical cell 100 with a thermal insulation system, according to an embodiment. As shown, the electrochemical cell 100 includes an anode material 110 disposed on an anode current collector 120, a cathode material 130 disposed on a cathode current collector 140, a separator 150 disposed between an anode material 110 and a cathode material 130, and an insulation system 160 disposed around and at least partially insulating the anode material 110, the anode current collector 120, the cathode material 130, the cathode current collector 140, and the separator 150. In some embodiments, the electrochemical cell 100 can include a vent 170 for the release of heat from the electrochemical cell 100. In some embodiments, the anode material 110 can include a semi-solid electrode material (e.g., a semi-solid electrode material the same or substantially similar to the semi-solid electrode materials described in the '159 patent). In some embodiments, the cathode material 130 can include a semi-solid electrode material (e.g., a semi-solid electrode material the same or substantially similar to the semi-solid electrode materials described in the '159 patent).

In some embodiments, the anode material 110 can include a semi-solid electrode material with a liquid electrolyte solution. In some embodiments, the liquid electrolyte solution in the anode material 110 can have an electrolyte salt concentration of at least about 1 M, at least about 1.5 M, at least about 2 M, at least about 2.5 M, at least about 3 M, at least about 3.5 M, at least about 4 M, or at least about 4.5 M. In some embodiments, the liquid electrolyte solution in the anode material 110 can have an electrolyte salt concentration of no more than about 5 M, no more than about 4.5 M, no more than about 4 M, no more than about 3.5 M, no more than about 3 M, no more than about 2.5 M, no more than about 2 M, or no more than about 1.5 M. Combinations of the above-referenced salt concentrations in the anode material 110 are also possible (e.g., at least about 1 M and no more than about 5 M or at least about 2 M and no more than about 4 M), inclusive of all values and ranges therebetween. In some embodiments, the liquid electrolyte solution in the anode material 110 can have an electrolyte salt concentration of about 1 M, about 1.5 M, about 2 M, about 2.5 M, about 3 M, about 3.5 M, about 4 M, about 4.5 M, or about 5 M.

In some embodiments, the cathode material 130 can include a semi-solid electrode material with a liquid electrolyte solution. In some embodiments, the liquid electrolyte solution in the cathode material 130 can have an electrolyte salt concentration of at least about 1 M, at least about 1.5 M, at least about 2 M, at least about 2.5 M, at least about 3 M, at least about 3.5 M, at least about 4 M, or at least about 4.5 M. In some embodiments, the liquid electrolyte solution in the cathode material 130 can have an electrolyte salt concentration of no more than about 5 M, no more than about 4.5 M, no more than about 4 M, no more than about 3.5 M, no more than about 3 M, no more than about 2.5 M, no more than about 2 M, or no more than about 1.5 M. Combinations of the above-referenced salt concentrations in the anode material 110 are also possible (e.g., at least about 1 M and no more than about 5 M or at least about 2 M and no more than about 4 M), inclusive of all values and ranges therebetween. In some embodiments, the liquid electrolyte solution in the cathode material 130 can have an electrolyte salt concentration of about 1 M, about 1.5 M, about 2 M, about 2.5 M, about 3 M, about 3.5 M, about 4 M, about 4.5 M, or about 5 M.

Semi-solid electrodes with electrolytes that have high salt concentrations can have better stability at high temperatures. In some cases, high salt concentrations in electrolytes can lead to better cycling and capacity retention through many cycles (e.g., 400 cycles or more). In some embodiments, the electrolyte can have a high heat capacity, such that the electrolyte creates a heat insulating effect. For example, an electrolyte can have a high salt concentration, such that the change in temperature the electrolyte undergoes due to incident energy is minimized. In some embodiments, the electrolyte can have a heat capacity of at least about 100 joules per mol-K (J/mol-K), at least about 110 J/mol-K, at least about 120 J/mol-K, at least about 130 J/mol-K, at least about 140 J/mol-K, at least about 150 J/mol-K, at least about 160 J/mol-K, at least about 170 J/mol-K, at least about 180 J/mol-K, at least about 190 J/mol-K, 200 J/mol-K, at least about 210 J/mol-K, at least about 220 J/mol-K, at least about 230 J/mol-K, at least about 240 J/mol-K, at least about 250 J/mol-K, at least about 260 J/mol-K, at least about 270 J/mol-K, at least about 280 J/mol-K, at least about 290 J/mol-K, or at least about 300 J/mol-K, inclusive of all values and ranges therebetween.

In some embodiments, the electrolyte solvent can include vinylene carbonate (VC), 1,3 propane sultone (PS), ethyl propionate (EP), 1,3-propanediol cyclic sulfate (PSA/TS), fluoroethylene carbonate (FEC), ethylene sulfite (ES), tris(2-ethylhexyl) phosphate (TOP), ethylene sulfate (DTD), ethyl acetate (EA), maleic anhydride (MA), ethylene carbonate (EC), propylene carbonate (PC), dimethyl carbonate (DMC), gamma-butyrolactone (GBL), ethyl methyl carbonate (EMC), or combinations thereof. In some embodiments, the electrolyte salt can include lithium bis(oxalato)borate (LiBOB), lithium hexafluorophosphate (LiPF₆), lithium bis(fluorosulfony)imide (LiFSI), or any combination thereof. In some embodiments, the electrolyte salt can have a concentration in the electrolyte of at least about 1 M, at least about 1.1 M, at least about 1.2 M, at least about 1.3 M, at least about 1.4 M, at least about 1.5 M, at least about 1.6 M, at least about 1.7 M, at least about 1.8 M, at least about 1.9 M, at least about 2 M, at least about 2.1 M, at least about 2.2 M, at least about 2.3 M, at least about 2.4 M, at least about 2.5 M, at least about 2.6 M, at least about 2.7 M, at least about 2.8 M, at least about 2.9 M, at least about 3 M, at least about 3.1 M, at least about 3.2 M, at least about 3.3 M, at least about 3.4 M, at least about 3.5 M, at least about 3.6 M, at least about 3.7 M, at least about 3.8 M, at least about 3.9 M, at least about 4 M, at least about 4.1 M, at least about 4.2 M, at least about 4.3 M, at least about 4.4 M, at least about 4.5 M, at least about 4.6 M, at least about 4.7 M, at least about 4.8 M, at least about 4.9 M, or at least about 5 M, inclusive of all values and ranges therebetween.

In some embodiments, the electrolyte can have a high flash point and low vapor pressure. In some embodiments, the electrolyte solvent can include both EC and PC. In some embodiments, the electrolyte solvent can include EC and GBL. In some embodiments, the electrolyte solvent can include EC, PC, GBL, and an ionic liquid. In some embodiments, the electrolyte solvent can include a fluorinated solvent. In some embodiments, the electrolyte solvent can include fluoroethylene carbonate (FEC), fluorinated ether (F-ether), or any combination thereof. In some embodiments, the electrolyte solvent can include a phosphate-based solvent. In some embodiments, the electrolyte solvent can include triphenylphosphate, triethoxyphosphazen-N-phosphoryldiethylester, hexamethylphosphoramide, or any combination thereof.

In some embodiments, the insulation system 160 can include a layer of insulative material. In some embodiments, the insulation system 160 can include multiple layers of insulative material. In some embodiments, the insulation system 160 can include 2 layers, 3 layers, 4 layers, 5 layers, 6 layers, 7 layers, 8 layers, 9 layers, 10 layers, or more than about 10 layers of insulative material.

In some embodiments, the insulation system 160 can include a multilayer emissive material. In some embodiments, the insulation system 160 can include multiple walls of insulative material. In some embodiments, the insulation system 160 can include multiple walls of insulative material spaced apart and interposed with a gas. In some embodiments, the insulation system 160 can inhibit conductive heat transfer. In some embodiments, the insulation system 160 can inhibit convective heat transfer. For example, the insulation system 160 can block the flow of heat transfer gases or create a barrier between gases moving outside of the electrochemical cell 100 and the components inside the electrochemical cell 100. In some embodiments, the insulation system 160 can inhibit radiative heat transfer.

In some embodiments, the insulation system 160 can include a heat shielding material. In some embodiments, the insulation system 160 can include a heat shielding coating. In some embodiments, the insulation system 160 can include a radiation barrier material or coating to avoid loss of heat through thermal conduction. In some embodiments, the insulation system 160 can use multilayer material with low emissivity. In some embodiments, the insulation system 160 can include one or more layers of aluminum. In some embodiments, the insulation system 160 can include one or more layers of plastic film lamination. In some embodiments, the insulation system 160 can include aluminum, silver, glass, plastic, polymers, Reflectix® material, or any other suitable material for insulation. In some embodiments, the insulation system 160 can include materials sputtered to walls (e.g., aluminum, silver).

In some embodiments, the insulation system 160 can include materials sputtered to walls, such that the sputtered material has a low porosity. In some embodiments, the sputtered material can have a porosity of less than about 5%, less than about 4%, less than about 3%, less than about 2%, less than about 1%, less than about 0.9%, less than about 0.8%, less than about 0.7%, less than about 0.6%, less than about 0.5%, less than about 0.4%, less than about 0.3%, less than about 0.2%, or less than about 0.1%, inclusive of all values and ranges therebetween. In some embodiments, the sputtered material can have a thickness of less than about 50 μm, less than about 45 μm, less than about 40 μm, less than about 35 μm, less than about 30 μm, less than about 25 μm, less than about 20 μm, less than about 15 μm, less than about 10 μm, less than about 5 μm, less than about 4 μm, less than about 3 μm, less than about 2 μm, or less than about 1 μm, inclusive of all values and ranges therebetween.

As shown, the insulation system 160 is integrated into one electrochemical cell. In some embodiments, the insulation system 160 can be integrated into an electrochemical cell system with multiple electrochemical cells. In other words, multiple electrochemical cells can be incorporated into a battery pack with an insulation system integrated therein. In some embodiments, the electrochemical cell system can include 1, 2, 3, 4, 5, 6, 7, 8, 9, 10, 11, 12, 13, 14, 16, 17, 18, 19, 20, at least about 20, at least about 30, at least about 40, at least about 50, at least about 60, at least about 70, at least about 80, at least about 90, at least about 100, at least about 200, at least about 300, at least about 400, at least about 500, at least about 600, at least about 700, at least about 800, at least about 900, or at least about 1,000 electrochemical cells. In some embodiments, the electrochemical cell system can include a hermetic seal battery pack.

In some embodiments, the thermal insulation system 160 can be incorporated into a module with multiple electrochemical cells utilized in parallel pairs. In some embodiments, one electrochemical cell in the module can have a low energy efficiency at low temperatures and generate excess heat in the module at a low temperature. For example, an electrochemical cell that generates excess heat can incorporate an anode and/or a cathode with a very low electrical conductivity and an electrolyte with a high ionic conductivity at a low temperature. An electrode with low electronic conductivity can generate excess heat, while high ionic conductivity can prevent lithium plating and ensure that a cell can operate at a low temperature. As electrochemical cell that generates excess heat can aid in operation of the module at low temperature (e.g., less than 0° C.). In some embodiments, an electrochemical cell that generates excess heat can have the same or substantially similar design to an adjacent electrochemical cell in the same module, but with an electrolyte that has a lower ionic conductivity. In some embodiments, an electrochemical cell that generates excess heat can have the same or substantially similar design to an adjacent electrochemical cell in the same module, but with a thicker anode and/or cathode. Examples of modules with multiple electrochemical cells with varying properties are described in U.S. Patent Publication 2021/0249695 (“the '695 publication”) entitled “Divided Energy Electrochemical Cells Systems and Methods of Producing the Same,” filed Feb. 8, 2021, the disclosure of which is hereby incorporated by reference in its entirety.

In some embodiments, the vent 170 can aid in cooling the electrochemical cell 100 if a temperature of the electrochemical cell 100 rises beyond a threshold value. In some embodiments, the electrochemical cell 100 can include one or more vents or fans (not shown) to dissipate heat generated from electrochemical reactions occurring in the electrochemical cell 100. In some embodiments, the electrochemical cell 100 can include a temperature sensor (not shown).

In some embodiments, the electrochemical cell 100 can experience a decrease in capacity of less than about 10%, less than about 9%, less than about 8%, less than about 7%, less than about 6%, less than about 5%, less than about 4%, less than about 3%, less than about 2%, less than about 1%, less than about 0.9%, less than about 0.8%, less than about 0.7%, less than about 0.6%, less than about 0.5%, less than about 0.4%, less than about 0.3%, less than about 0.2%, or less than about 0.1% after 400 cycles, inclusive of all values and ranges therebetween. In some embodiments, the electrochemical cell 100 can experience a growth of area specific impedance of less than about 40%, less than about 39%, less than about 38%, less than about 37%, less than about 36%, less than about 35%, less than about 34%, less than about 33%, less than about 32%, less than about 31%, less than about 30%, less than about 29%, less than about 28%, less than about 27%, less than about 26%, less than about 25%, less than about 24%, less than about 23%, less than about 22%, less than about 21%, or less than about 20% after 400 cycles, inclusive of all values and ranges therebetween.

In some embodiments, the electrochemical cell 100 can include a pouch (not shown). In some embodiments, the anode material 110, the anode current collector 120, the cathode material 130, the cathode current collector 140, and the separator 150 can be disposed in the pouch and the pouch can be disposed in the insulation system 160. In some embodiments, the pouch can include a polymer film. In some embodiments, the pouch can include a first polymer film bonded to a second polymer film. In some embodiments, the pouch can include any of the properties of the pouches described in U.S. Pat. No. 10,181,587 (“the '587 patent”) entitled “Single Pouch Battery Cells and Methods of Manufacture,” filed Jun. 17, 2016, the disclosure of which is hereby incorporated by reference in its entirety.

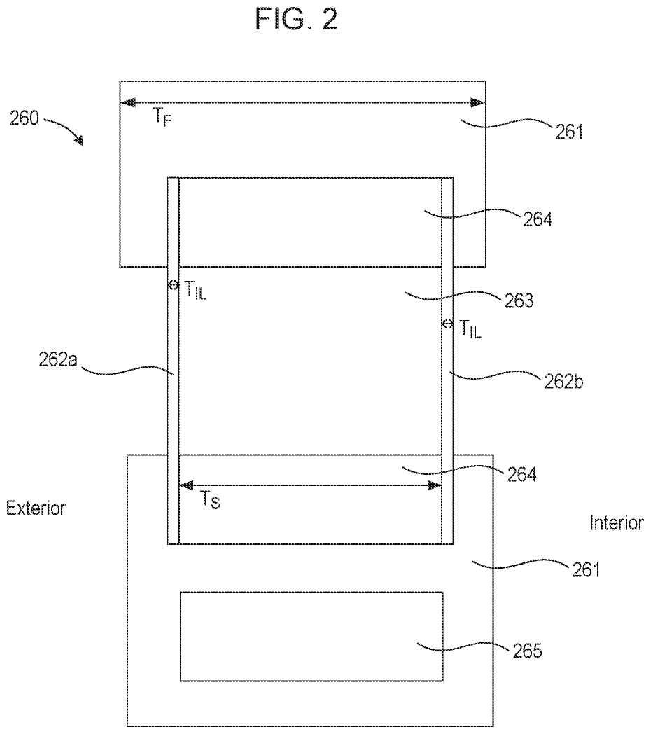

FIG. 2 shows an illustration of an insulation system 260, according to an embodiment. FIG. 2 shows a cross-sectional view of the insulation system 260. As shown, the insulation system 260 includes a frame 261, a first insulation layer 262a, a second insulation layer 262b (collectively referred to as insulation layers 262), an insulation space 263, a spacer 264, and a filler material 265. As depicted in FIG. 2, an interior space (i.e., a space that contains an anode, a cathode, and a separator (not shown)) is positioned on the right side of the frame 261 and an exterior space (i.e., a space external to the electrochemical cell) is positioned on the left side of the frame 261.

In some embodiments, the frame 261 can provide structural rigidity to electrochemical cells and electrochemical cell systems. In some embodiments, the frame 261 can hold the insulation layers 262 in place. In some embodiments, the frame 261 can house all of the components of the thermal insulation system 260. In other words, each of the components of the thermal insulation system 260 can be contained in the frame 261. In some embodiments, the frame 261 can be composed of polymers, plastics, polyethylene, polypropylene, a metal, a composite material, or any combination thereof. In some embodiments, the frame 261 can provide heat insulation to keep heat from exiting the electrochemical cell.

As shown, the frame 261 has a frame thickness T_{F}. In some embodiments, the frame thickness T_{F} can be at least about 50 μm, at least about 100 μm, at least about 200 μm, at least about 300 μm, at least about 400 μm, at least about 500 μm, at least about 600 μm, at least about 700 μm, at least about 800 μm, at least about 900 μm, at least about 1 mm, at least about 1.1 mm, at least about 1.2 mm, at least about 1.3 mm, at least about 1.4 mm, at least about 1.5 mm, at least about 1.6 mm, at least about 1.7 mm, at least about 1.8 mm, or at least about 1.9 mm. In some embodiments, the frame thickness T_{F} can be no more than about 2 mm, no more than about 1.9 mm, no more than about 1.8 mm, no more than about 1.7 mm, no more than about 1.6 mm, no more than about 1.5 mm, no more than about 1.4 mm, no more than about 1.3 mm, no more than about 1.2 mm, no more than about 1.1 mm, no more than about 1 mm, no more than about 900 μm, no more than about 800 μm, no more than about 700 μm, no more than about 600 μm, no more than about 500 μm, no more than about 400 μm, no more than about 300 μm, no more than about 200 μm, or no more than about 100 μm. Combinations of the above-referenced frame thickness T_{F} values are possible (e.g., at least about 50 μm and no more than about 2 mm or at least about 200 μm and no more than about 500 μm), inclusive of all values and ranges therebetween. In some embodiments, the frame thickness T_{F} can be about 50 μm, about 100 μm, about 200 μm, about 300 μm, about 400 μm, about 500 μm, about 600 μm, about 700 μm, about 800 μm, about 900 μm, about 1 mm, about 1.1 mm, about 1.2 mm, about 1.3 mm, about 1.4 mm, about 1.5 mm, about 1.6 mm, about 1.7 mm, about 1.8 mm, about 1.9 mm, or about 2 mm.

In some embodiments, the insulation layers 262 can be composed of glass, polymers, polycarbonate, polypropylene, fiberglass, or any other suitable material, or combinations thereof. As shown, the insulation system 260 includes 2 insulation layers 262. In some embodiments, the insulation system can include 1, 3, 4, 5, 6, 7, 8, 9, 10 or at least about 10 insulation layers 262.

As shown, the insulation layers 262 each have a thickness T_{IL}. In some embodiments, the thickness T_{IL} of each of the insulation layers 262 can be at least about 20 μm, at least about 30 μm, at least about 40 μm, at least about 50 μm, at least about 60 μm, at least about 70 μm, at least about 80 μm, at least about 90 μm, at least about 100 μm, at least about 150 μm, at least about 200 μm, at least about 250 μm, at least about 300 μm, at least about 350 μm, at least about 400 μm, or at least about 450 μm. In some embodiments, the thickness T_{IL} of each of the insulation layers 262 can be no more than about 500 μm, no more than about 450 μm, no more than about 400 μm, no more than about 350 μm, no more than about 300 μm, no more than about 250 μm, no more than about 200 μm, no more than about 150 μm, no more than about 100 μm, no more than about 90 μm, no more than about 80 μm, no more than about 70 μm, no more than about 60 μm, no more than about 50 μm, no more than about 40 μm, or no more than about 30 μm.

Combinations of the above-referenced thicknesses T_{IL} of each of the insulation layers 262 are also possible (e.g., at least about 20 μm and no more than about 500 μm or at least about 100 μm and no more than about 300 μm), inclusive of all values and ranges therebetween. In some embodiments, the thickness T_{IL} of each of the insulation layers 262 can be about 20 μm, about 30 μm, about 40 μm, about 50 μm, about 60 μm, about 70 μm, about 80 μm, about 90 μm, about 100 μm, about 150 μm, about 200 μm, about 250 μm, about 300 μm, about 350 μm, about 400 μm, about 450 μm, or about 500 μm. As shown, the first insulation layer 262a and the second insulation layer 262b each have the same thickness T_{IL}. In some embodiments, the first insulation layer 262a can have a first thickness and the second insulation layer 262b can have a second thickness, the second thickness different from the first thickness. In some embodiments, the first thickness can include any of the aforementioned values of T_{IL}. In some embodiments, the second thickness can include any of the aforementioned values of T_{IL}.

In some embodiments, the first insulation layer 262a and/or the second insulation layer 262b can have a material sputtered thereon. In some embodiments, the first insulation layer 262a and/or the second insulation layer 262b can include aluminum or silver sputtered thereon. In some embodiments, a material can be sputtered onto the second insulation layer 262b on the interior of the electrochemical cell.

In some embodiments, the insulation space 263 can include an inert gas. In some embodiments, the inert gas can include nitrogen, argon, helium, or any other inert gas or combinations thereof. In some embodiments, the insulation space 263 can be at least partially evacuated. In some embodiments, the insulation space 263 can be evacuated to a pressure of less than about 0.9 bar (absolute), less than about 0.8 bar, less than about 0.7 bar, less than about 0.6 bar, less than about 0.5 bar, less than about 0.4 bar, less than about 0.3 bar, less than about 0.2 bar, less than about 0.1 bar, less than about 0.09 bar, less than about 0.08 bar, less than about 0.07 bar, less than about 0.06 bar, less than about 0.05 bar, less than about 0.04 bar, less than about 0.03 bar, less than about 0.02 bar, less than about 0.01 bar, less than about 0.005 bar, less than about 0.001 bar, less than about 5·10⁻⁴ bar, less than about 1·10⁻⁴ bar, less than about 5·10⁻⁵ bar, less than about 1·10⁻⁵ bar, less than about 5·10⁻⁶ bar, less than about 1·10⁻⁶ bar, less than about 5·10⁻⁷ bar, less than about 1·10⁻⁷ bar, less than about 5·10⁻⁸ bar, less than about 1·10⁻⁸ bar, less than about 5·10⁻⁹ bar, less than about 1·10⁻⁹ bar, less than about 5·10⁻¹⁰ bar, or less than about 1·10⁻¹⁰ bar, inclusive of all values and ranges therebetween.

In some embodiments, the spacer 264 can be used to maintain proper spacing between the first insulation layer 262a and the second insulation layer 262b. As shown, the spacer 264 has a spacer thickness T_{S}. In some embodiments, the spacer 264 can have a spacer thickness T_{S} such that the insulation layers 262 are kept spaced apart at a desired distance. In some embodiments, the spacer thickness T_{S} can be at least about 50 μm, at least about 100 μm, at least about 150 μm, at least about 200 μm, at least about 250 μm, at least about 300 μm, at least about 350 μm, at least about 400 μm, or at least about 450 μm. In some embodiments, the spacer thickness T_{S} can be no more than about 500 μm, no more than about 450 μm, no more than about 400 μm, no more than about 350 μm, no more than about 300 μm, no more than about 250 μm, no more than about 200 μm, no more than about 150 μm, or no more than about 100 μm. Combinations of the above-referenced spacer thickness T_{S} values are also possible (e.g., at least about 50 μm and no more than about 500 μm or at least about 100 μm and no more than about 300 μm), inclusive of all values and ranges therebetween. In some embodiments, the spacer thickness T_{S} can be about 50 μm, about 100 μm, about 150 μm, about 200 μm, about 250 μm, about 300 μm, about 350 μm, about 400 μm, about 450 μm, or about 500 μm.

The filler material 265 can add an additional element of heat insulation. As shown, the filler material 265 is integrated into the frame 261. In some embodiments, the filler material 265 can be integrated into the insulation layers 262. In some embodiments, the filler material 265 can be a discontinuity in the frame 261, such that the frame 261 is discontinuous or heterogeneous along the frame thickness T_{F}. In some embodiments, the filler material 265 can be composed of a different material from the frame 261. In some embodiments, the filler material 265 can be composed of an insulative material. In some embodiments, the filler material 265 can include polyurethane, foam, fiberglass, a polymer, or any other suitable insulating material.

In some embodiments, the filler material 265 can occupy a portion of the volume of the insulation system 260. In some embodiments, the filler material 265 can occupy at least about 1%, at least about 2%, at least about 3%, at least about 4%, at least about 5%, at least about 6%, at least about 7%, at least about 8%, at least about 9%, at least about 10%, at least about 20%, at least about 30%, at least about 40%, at least about 50%, at least about 60%, or at least about 70% of the volume of the insulation system 260. In some embodiments, the filler material 265 can occupy no more than about 80%, no more than about 70%, no more than about 60%, no more than about 50%, no more than about 40%, no more than about 30%, no more than about 20%, no more than about 10%, no more than about 9%, no more than about 8%, no more than about 7%, no more than about 6%, no more than about 5%, no more than about 4%, no more than about 3%, or no more than about 2% of the volume of the insulation system 260. Combinations of the above-referenced values of portions of the insulation system 260 occupied by the filler material 265 are also possible (e.g., at least about 1% and no more than about 80% or at least about 5% and no more than about 20%), inclusive of all values and ranges therebetween. In some embodiments, the filler material 265 can occupy about 1%, about 2%, about 3%, about 4%, about 5%, about 6%, about 7%, about 8%, about 9%, about 10%, about 20%, about 30%, about 40%, about 50%, about 60%, about 70%, or about 80% of the volume of the insulation system 260.

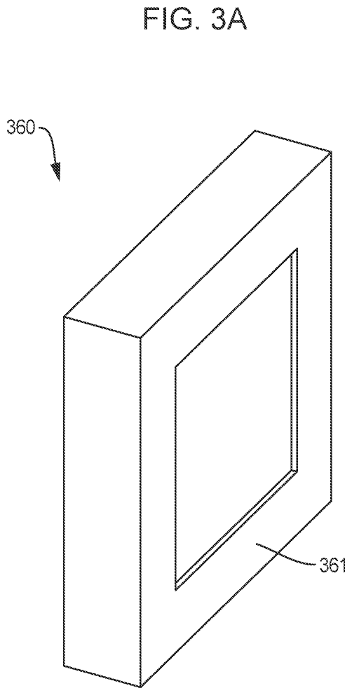

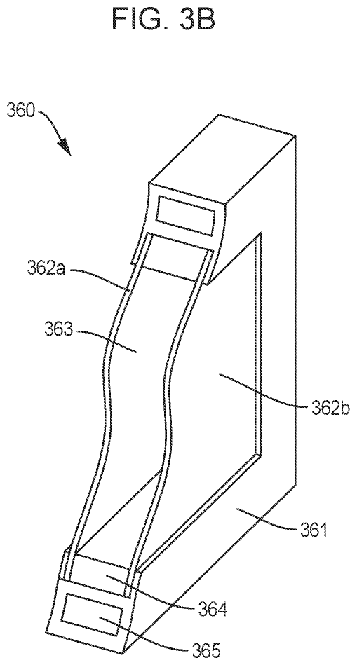

FIGS. 3A-3B illustrate a thermal insulation system 360. FIG. 3A shows an outside view of the thermal insulation system 360, while FIG. 3B shows a cross-sectional view of the thermal insulation system 360. As shown, the thermal insulation system 360 includes a frame 361, a first insulation layer 362a, a second insulation layer 362b (collectively referred to as insulation layers 362), an insulation space 363, a spacer 364, and a filler material 365. In some embodiments, the frame 361, the insulation layers 362, the insulation space 363, the spacer 364, and the filler material 365 can be the same or substantially similar to the frame 261, the insulation layers 262, the insulation space 263, the spacer 264, and the filler material 265, as described above with reference to FIG. 2. Thus, certain aspects of the frame 361, the insulation layers 362, the insulation space 363, the spacer 364, and the filler material 365 are not described in greater detail herein.

FIGS. 3A-3B show illustrations of the thermal insulation system 360 and demonstrate convection and conduction of heat. As shown, the area to the right of the insulation system 360 represents the inside of an electrochemical cell while the area to the left of the insulation system represents the outside of the electrochemical cell. In use, heat flows from inside the electrochemical cell to outside the electrochemical cell. Conduction takes place through the insulation layers 362 and across still air. Convection takes place in the insulation space. Movement both inside and outside of the electrochemical cell can induce convection. In some cases, the convection is free convection. In some cases, the convection is forced convection. By designing the insulation system to minimize the amount of heat that escapes, electrochemical cells can be operated at high temperatures with little or no heat input.

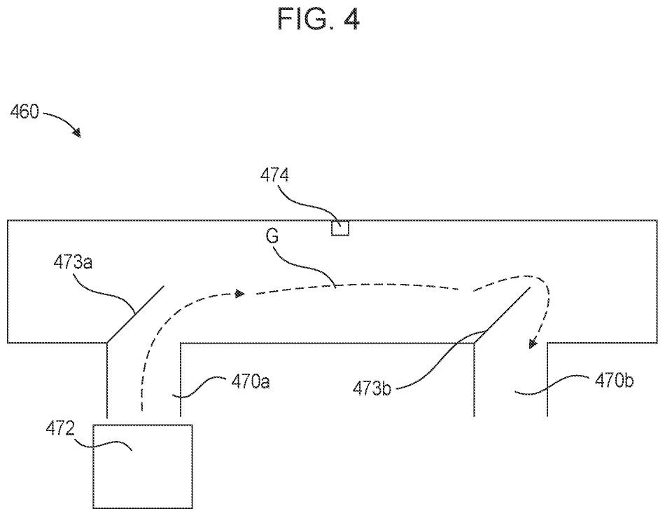

FIG. 4 illustrates an insulation system 460 with an inlet vent 470a and an outlet vent 470b (collectively referred to as vents 470). While not shown, the insulation system 460 can include any of the components of the insulation system 160, the insulation system 260, and/or the insulation system 360, as described above with reference to FIG. 1, FIG. 2, and FIG. 3, respectively. An electrochemical cell can be disposed in the insulation system 460. As shown, the insulation system 460 includes the vents 470, a blower 472, an inlet gate 473a, an outlet gate 473b (collectively referred to as gates 473), and a temperature sensor 474. Gas flow is represented by gas flow path G.

In some embodiments, the vents 470, blower 472, gates 473, and temperature sensor 474 can aid in maintaining an electrochemical cell's operating temperature at a desired level. In some embodiments, the desired operating temperature of the electrochemical cell can be at least about −5° C., at least about 0° C., at least about 5° C., at least about 10° C., at least about 15° C., at least about 20° C., at least about 25° C., at least about 30° C., at least about 35° C., at least about 40° C., at least about 45° C., at least about 50° C., or at least about 55° C. In some embodiments, the desired operating temperature of the electrochemical cell can be no more than about 60° C., no more than about 55° C., no more than about 50° C., no more than about 45° C., no more than about 40° C., no more than about 35° C., no more than about 30° C., no more than about 25° C., no more than about 20° C., no more than about 15° C., no more than about 10° C., no more than about 5° C., or no more than about 0° C. Combinations of the above-referenced desired operating temperatures are also possible (e.g., at least about −5° C. and no more than about 60° C. or at least about 10° C. and no more than about 30° C.), inclusive of all values and ranges therebetween. In some embodiments, the desired operating temperature of the electrochemical cell can be about −5° C., about 0° C., about 5° C., about 10° C., about 15° C., about 20° C., about 25° C., about 30° C., about 35° C., about 40° C., about 45° C., about 50° C., about 55° C., or about 60° C.

In some embodiments, the vents 470 can promote flow of air (or other gases) through the insulation system 460 to contact the electrochemical cell disposed therein. In some embodiments, the vents 470 can include openings in the insulation system 460. In some embodiments, the vents 470 can include grated openings. In some embodiments, the vents 470 can be sized to allow for flow of gas through the insulation system 460 to contact the electrochemical cell.

In some embodiments, the blower 472 can include a fan. In some embodiments, the blower 472 can circulate gas through the insulation system 460 at a rate of at least about 1 standard cubic centimeter per minute (SCCM), at least about 5 SCCM, at least about 10 SCCM, at least about 50 SCCM, at least about 100 SCCM, at least about 500 SCCM, at least about 1,000 SCCM, or at least about at least about 5,000 SCCM. In some embodiments, the blower 472 can circulate gas through the insulation system 460 at a rate of no more than about 10,000 SCCM, no more than about 5,000 SCCM, no more than about 1,000 SCCM, no more than about 500 SCCM, no more than about 100 SCCM, no more than about 50 SCCM, no more than about 10 SCCM, or no more than about 5 SCCM. Combinations of the above-referenced gas circulation rates induced by the blower 472 are also possible (e.g., at least about 1 SCCM and no more than about 10,000 SCCM or at least about 50 SCCM and no more than about 1,000 SCCM), inclusive of all values and ranges therebetween. In some embodiments, the blower 472 can circulate gas through the insulation system 460 at a rate of about 1 SCCM, about 5 SCCM, about 10 SCCM, about 50 SCCM, about 100 SCCM, about 500 SCCM, about 1,000 SCCM, about 5,000 SCCM, or about 10,000 SCCM.

In some embodiments, the blower 472 can circulate air. In some embodiments, the blower 472 can circulate an inert gas, such as nitrogen, argon, neon, helium, or any combination thereof. In some embodiments, the gas that the blower 472 circulates can be subject to cooling before entering the blower 472 (e.g., a refrigeration cycle). In some embodiments, the blower 472 can include a cooling mechanism disposed therein. In some embodiments, the gas that the blower circulates can be pressurized prior to entering the blower 472.

The inlet gate 473a and the outlet gate 473b can regulate flow of gas into and out of the insulation system 460. In some embodiments, the gates 473 can include valves. In some embodiments, the gates 473 can include pressure actuated valves. For example, the outlet gate 473b can release gas from the insulation system 460 when the pressure from the insulation system exceeds a threshold value. In some embodiments, the gates 473 can be closed, partially open, or fully open during operation of the electrochemical cell.

As shown, the temperature sensor 474 is disposed on a wall of the insulation system 460. In some embodiments, the temperature sensor 474 can be integrated into electrodes or any other electrochemical cell parts (e.g., current collectors, separators). In some embodiments, the temperature sensor 474 can be disposed on the inlet gate 473a. In some embodiments, the temperature sensor 474 can be disposed on the outlet gate 473b. In some embodiments, the temperature sensor 474 can be disposed on the inlet vent 470a and/or the outlet vent 470b. In some embodiments, the temperature sensor 474 can monitor fluid velocity. In some embodiments, multiple temperature sensors 474 can be disposed at different locations throughout the insulation system 460 and the electrochemical cell.

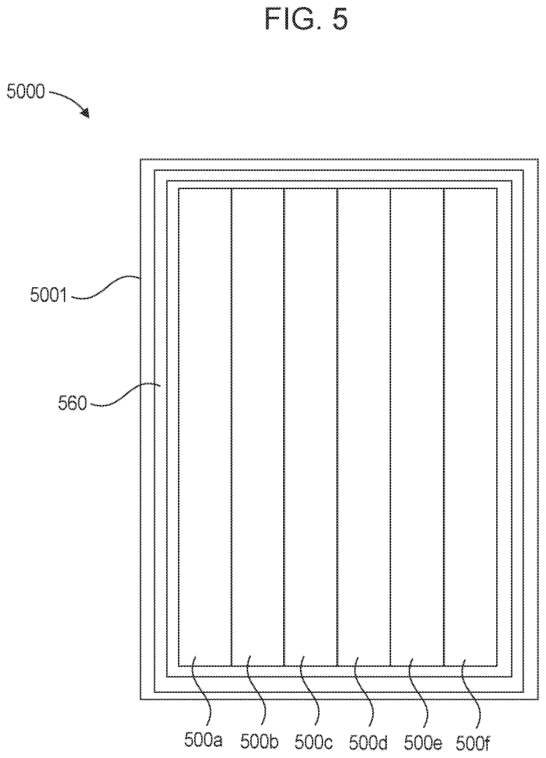

FIG. 5 is an illustration of an electrochemical cell module 5000 with an insulation system 560, according to an embodiment. As shown, the electrochemical cell module 5000 includes electrochemical cells 500a, 500b, 500c, 500d, 500e, 500f (collectively referred to as electrochemical cells 500) arranged in a stacked configuration. In some embodiments, the electrochemical cells 500 can be housed in a casing 5001. In some embodiments, the electrochemical cells 500 can be the same or substantially similar to the electrochemical cells 100, as described above with reference to FIG. 1. In some embodiments, the thermal insulation system 560 can be the same or substantially similar to the insulation system 160, as described above with reference to FIG. 1. Thus, certain aspects of the electrochemical cells 500 and the insulation system 560 are not described in greater detail herein.

In some embodiments, the insulation system 560 can include insulating material disposed between the electrochemical cells 500 and an inner wall of the casing 5001. In some embodiments, the insulation system 560 can include insulating material disposed between one or more of the electrochemical cells 500 and another of the electrochemical cells 500 (e.g., between electrochemical cell 500a and electrochemical cell 500b, between electrochemical cell 500b and electrochemical cell 500c, etc.). In some embodiments, the insulation system 560 can create thermal isolation between the electrochemical cells 500 and the casing 5001. In some embodiments, the electrochemical cells 500 can be held together via compression plates (not shown). In some embodiments, the compression plates can include any of the properties of the compression plates described in U.S. Provisional Patent Application No. 63/448,534 (“the '534 application”), filed Feb. 27, 2023 and titled “Compression Systems for Electrochemical Cells and Electrochemical Cell Stacks,” the entire disclosure of which is hereby incorporated by reference in its entirety. In some embodiments, the insulation system 560 can create thermal isolation between the electrochemical cells 500 and the compression plates. In some embodiments, the insulation system 560 can be disposed at the ends of the electrochemical cells 500 (e.g., on the outside of the electrochemical cell 500a and on the outside of the electrochemical cell 500b), without additional insulation layers disposed between the other electrochemical cells 500.

In some embodiments, the electrochemical cell module 5000 can be designed to reduce external heat transfer. In some embodiments, the electrochemical cell module 5000 can be designed to maximize the volume to surface area ratio of the electrochemical cell module 5000. In other words, the electrochemical cell module 5000 can have a large ratio of volume of electrochemical cells 500 to the surface area of the electrochemical cells 500 not covered by insulative material or other electrochemical cells 500. In some embodiments, less than about 10%, less than about 9%, less than about 8%, less than about 7%, less than about 6%, less than about 5%, less than about 4%, less than about 3%, less than about 2%, or less than about 1% of the surface area of the electrochemical cells 500 can be exposed to an external environment (i.e., not covered by other electrochemical cells or insulative material).

As shown, the electrochemical cell module 5000 includes 6 electrochemical cells 500. In some embodiments, the electrochemical cell module 5000 can include 2, 3, 4, 5, 6, 7, 8, 9, 10, at least about 10, at least about 20, at least about 30, at least about 40, at least about 50, at least about 60, at least about 70, at least about 80, at least about 90, at least about 100, at least about 200, at least about 300, at least about 400, at least about 500, at least about 600, at least about 700, at least about 800, at least about 900, or at least about 1,000 electrochemical cells 500, inclusive of all values and ranges therebetween. In some embodiments, each of the electrochemical cells 500 can be the same or substantially similar. In some embodiments, one or more of the electrochemical cells 500 can be different from one another. For example, the electrochemical cell 500a can have a first chemistry, while the electrochemical cell 500b has a second chemistry, the second chemistry different from the first chemistry. As another example, the electrochemical cell 500a can have a first anode thickness and the electrochemical cell 500b can have a second anode thickness, the second anode thickness different from the first anode thickness. As another example, the electrochemical cell 500a can have a first cathode thickness and the electrochemical cell 500b can have a second cathode thickness, the second cathode thickness different from the first cathode thickness. In some embodiments, the electrochemical cells 500 can have any of the properties of the electrochemical cells in the '695 publication.

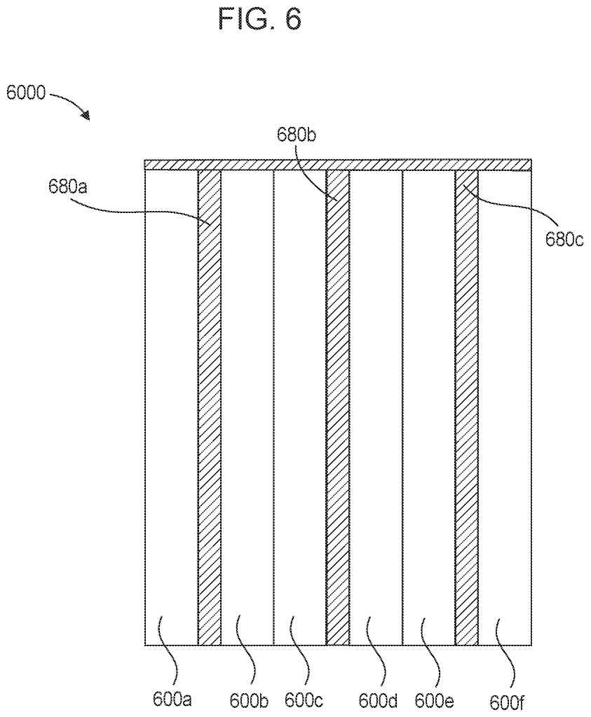

FIG. 6 is an illustration of an electrochemical cell module 6000 with electrochemical cells 600a, 600b, 600c, 600d, 600e, 600f (collectively referred to as electrochemical cells 600) and heat transfer fins 680a, 680b, 680c (collectively referred to as heat transfer fins 680). In some embodiments, the electrochemical cells 600 can be the same or substantially similar to the electrochemical cells 500, as described above with reference to FIG. 5. Thus, certain aspects of the electrochemical cells 600 are not described in greater detail herein.

In some embodiments, the heat transfer fins 680 can be distributed throughout the electrochemical cell module 6000 and interconnected to help evenly distribute heat throughout the electrochemical cell module 6000. In some embodiments, the heat transfer fins 680 can have any of the properties described in U.S. Provisional Patent Application No. 63/416,774 (“the '774 application”), filed Oct. 17, 2022 and titled “Heat Transfer Plates in Electrochemical Cell Systems, and Methods of Producing the Same,” the disclosure of which is hereby incorporated by reference in its entirety. In some embodiments, the electrochemical cell module 6000 can include conduits for the passage of cooling fluid. In some embodiments, the conduits can run through the heat transfer fins 680. In some embodiments, the conduits can be external to the heat transfer fins 680. In some embodiments, the cooling fluid can be drained from the conduits at low temperatures to increase temperature in the electrochemical cell module 6000. In some embodiments, air can pass through the electrochemical cell module 6000 via air channels. In some embodiments, the electrochemical cell module 6000 can include dampers that close the air channels at low temperatures to retain heat. In some embodiments, the dampers can close the air channels at low temperatures to retain heat while the electrochemical cell module 6000 is at rest (i.e., when the electrochemical cells 600 are not in operation). In some embodiments, the heat retention measures can be implemented when the electrochemical cell module 6000 has a volume average temperature below a prescribed threshold temperature. In some embodiments, the threshold temperature can be about 10° C., about 5° C., about 0° C., about −5° C., about −10° C., about −15° C., about −20° C., about −25° C., about −30° C., about −35° C., or about −40° C., inclusive of all values and ranges therebetween.

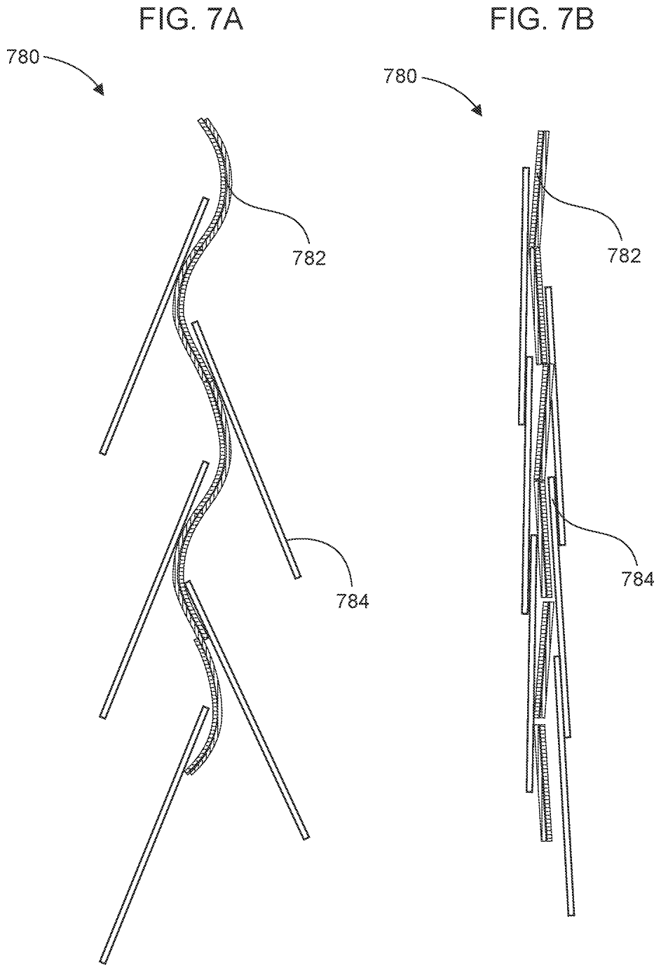

FIGS. 7A-7B show a heat transfer fin 780 with a thermal conductivity that decreases as temperature decreases. As shown, the heat transfer fin 780 includes bending strips 782 and a heat transfer material 784. FIG. 7A depicts the heat transfer fin 780 at a low temperature while FIG. 7B depicts the heat transfer fin 780 at a high temperature. The bending strips 782 can be composed of a material selected to at least partially straighten at a high temperature. At the low temperature in FIG. 7A, the bending strips 782 maintain their bent shape and the heat transfer material 784 branches out, such that the heat transfer material 784 touches nearby electrochemical cells. The heat transfer material 784 would effectively transfer heat in such a configuration. When the bending strips 782 straighten at a high temperature, the heat transfer material 784 no longer maintains as much contact with adjacent electrochemical cells as at the lower temperature. Thus, heat transfer between adjacent electrochemical cells is reduced in the configuration of FIG. 7B. As shown, the heat transfer fin 780 includes a plurality of bending strips 782. In some embodiments, the heat transfer fin 780 can include a single bending strip 782 that maintains its bent shape at low temperatures and straightens at high temperatures. In some embodiments, the bending strips 782 can be composed of a material configured to straighten at a prescribed temperature. In some embodiments, the prescribed temperature can be about 10° C., about 5° C., about 0° C., about −5° C., about −10° C., about −15° C., about −20° C., about −25° C., about −30° C., about −35° C., or about −40° C., inclusive of all values and ranges therebetween. In some embodiments, the heat transfer fin 780 can be disposed inside a casing (not shown), such that the heat transfer material 784 contacts the walls of the casing at lower temperatures and the heat transfer material 784 does not contact the walls of the casing at higher temperatures. In some embodiments, at least a portion of the pieces of heat transfer material 784 can discontinue contacting adjacent electrochemical cells at elevated temperatures. In some embodiments, all or substantially all of the pieces of heat transfer material 784 can discontinue contacting adjacent electrochemical cells at elevated temperatures.

As shown, the bending strips 782 can include a bi-strip (i.e., 2 layers of material). In some embodiments, the bending strips 782 can include a 1, 2, 3, 4, 5, 6, 7, 8, 9, or 10 layers, inclusive of all values and ranges therebetween. In some embodiments, the bending strips 782 can be composed of tungsten, titanium, platinum, carbon steel, iron, steel, nickel, stainless steel, gold, copper, silver, brass, aluminum, lead, or any combination thereof. In some embodiments, the heat transfer material 784 can be composed of copper, gold, silver, nickel, nickel titanium alloy, titanium, aluminum, steel, brass, iron, carbon steel, tungsten, platinum, lead, or any combination thereof.

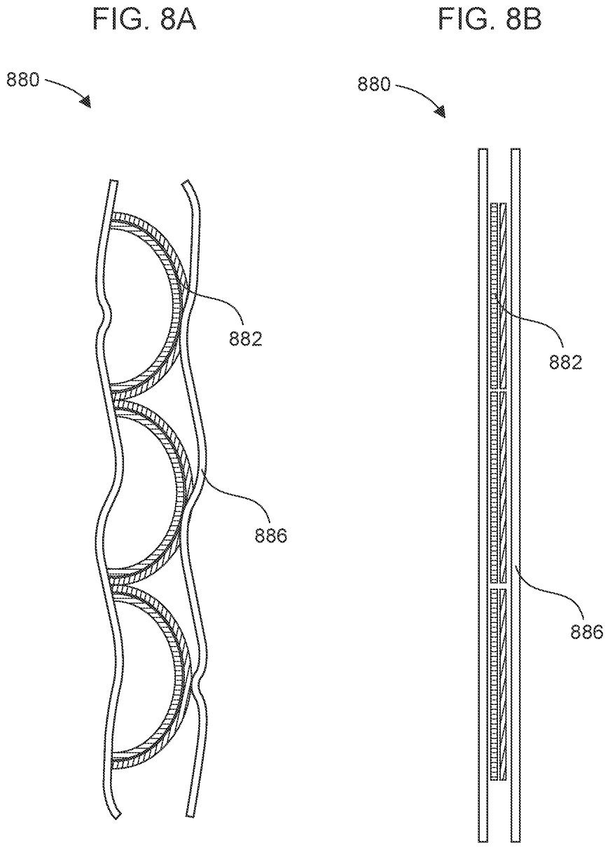

FIGS. 8A-8B show a heat transfer fin 880 with a thermal conductivity that decreases as temperature decreases. As shown, the heat transfer fin 880 includes bending strips 882 and an insulating material 886. FIG. 8A shows the heat transfer fin 880 below a threshold temperature while FIG. 8B shows the heat transfer fin 880 above a threshold temperature. As shown, the bending strips 882 deform and at least partially straighten above a threshold temperature. In the configuration of FIG. 8A, the insulating material 886 is pressed against adjacent electrochemical cells, while a gap exists between the insulating material 886 and adjacent electrochemical cells in FIG. 8B. In other words, as the temperature increases and the heat transfer fin 880 flattens, heat can more quickly exit the electrochemical cells because the insulating material 886 is not pressed against the electrochemical cells, keeping the heat in the electrochemical cells. In some embodiments, the bending strips 882 can be composed of tungsten, titanium, platinum, carbon steel, iron, steel, nickel, stainless steel, gold, copper, silver, brass, aluminum, lead, or any combination thereof. In some embodiments, the insulating material 886 can be composed of expanded fiber, mesh, and/or foam materials that can expand to fill a volume at a given pressure (e.g., atmospheric pressure). In some embodiments, a vacuum can be applied to the insulating material 886 to remove air from the insulating material 886, increasing the thermal conductivity of the insulating material 886 by compaction, when more insulation is used in the heat transfer fin 880. In some embodiments, the heat transfer fin 880 can be returned to atmospheric pressure or positively pressurized to increase the insulating value of the heat transfer fin 880.

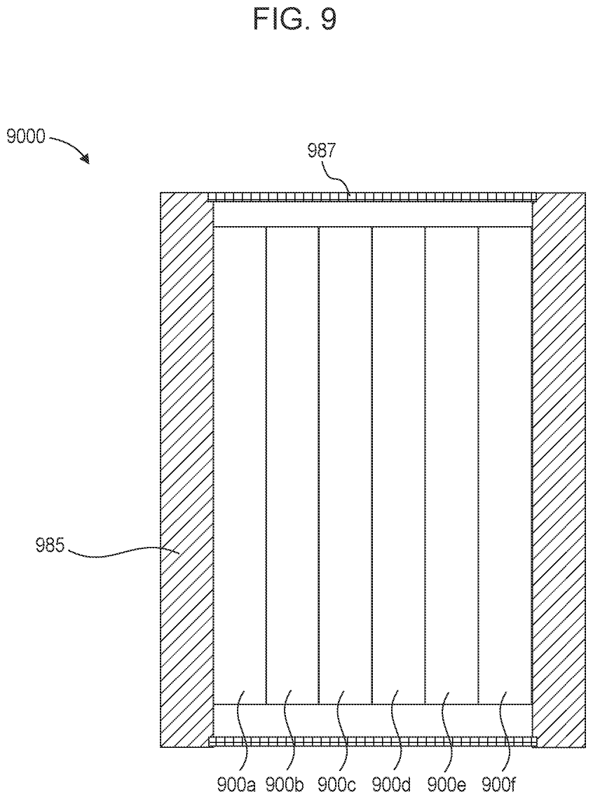

FIG. 9 shows an electrochemical cell module 9000 with a thermal insulation system, according to an embodiment. As shown, the electrochemical cell module 9000 includes electrochemical cells 900a, 900b, 900c, 900d, 900e, 900f (collectively referred to as electrochemical cells 900), end plates 985, and tie rods 987. In some embodiments, the electrochemical cells 900 can be the same or substantially similar to the electrochemical cells 500, as described above with reference to FIG. 5. Thus, certain aspects of the electrochemical cells 900 are not described in greater detail herein.

As shown, the end plates 985 hold and press together the electrochemical cells 900. The end plates 985 can shrink at low temperatures to reduce externally applied pressure and increase internal resistance of the electrochemical cells 900. In some embodiments, the end plates 985 can have a high thermal expansion coefficient, such that the end plates 985 expand and contract significantly with changing temperatures. As shown, the tie rods 987 hold the end plates 985 in place. In some embodiments, the tie rods 987 can have a low thermal expansion coefficient such that they contract and squeeze the end plates 985 together at low temperature. In some embodiments, the tie rods 987 can include straps. In some embodiments, the end plates 985 can have a larger coefficient of thermal expansion than the tie rods 987, such that the end plates 985 shrink more at low temperature to reduce pressure in the electrochemical cell module 9000. In some embodiments, the tie rods 987 can be composed of metal, steel, aluminum, or any combination thereof. In some embodiments, the end plates 985 can be composed of a polymer, polypropylene, polycarbonate, acetal, polyethylene, or any combination thereof.

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “set” and “plurality” can refer to multiple features or a singular feature with multiple parts. For example, when referring to a set of electrodes, the set of electrodes can be considered as one electrode with multiple portions, or the set of electrodes can be considered as multiple, distinct electrodes. Additionally, for example, when referring to a plurality of electrochemical cells, the plurality of electrochemical cells can be considered as multiple, distinct electrochemical cells or as one electrochemical cell with multiple portions. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

As used herein, the term “semi-solid” refers to a material that is a mixture of liquid and solid phases, for example, such as a particle suspension, a slurry, a colloidal suspension, an emulsion, a gel, or a micelle.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisional s, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. An electrochemical cell, comprising:
an anode material disposed on an anode current collector;
a cathode material disposed on a cathode current collector;
a separator disposed between the anode material and the cathode material; and
an insulating structure disposed around and configured to contain the anode, the anode current collector, the cathode, the cathode current collector, and the separator,
wherein at least one of the anode and the cathode includes a semi-solid electrode material, the semi-solid electrode material including an active material in a liquid electrolyte, the liquid electrolyte having an electrolyte salt concentration of at least about 2.0 M.

2. The electrochemical cell of claim 1, wherein the insulating structure includes a frame with a first wall and a second wall disposed therein.

3. The electrochemical cell of claim 2, wherein the first wall and the second wall are at least partially composed of glass.

4. The electrochemical cell of claim 2, wherein a region between the first wall and the second wall is evacuated.

5. The electrochemical cell of claim 2, wherein a region between the first wall and the second wall is filled with an inert gas.

6. The electrochemical cell of claim 1, wherein the insulating frame includes a laminate material.

7. The electrochemical cell of claim 6, wherein the laminate material includes Reflectix® insulating material.

8. The electrochemical cell of claim 1, wherein the insulating frame includes a sputtered material.

9. The electrochemical cell of claim 8, wherein the sputtered material includes at least one of silver or aluminum.

10. The electrochemical cell of claim 1, further comprising:
a vent, the vent integrated into the insulating frame.

11. The electrochemical cell of claim 10, wherein the vent includes a first valve configured to allow air into the electrochemical cell from outside the electrochemical cell and a second valve configured to allow air out of the electrochemical cell from inside the electrochemical cell.

12. The electrochemical cell of claim 11, further comprising an air blower configured to push air through the first valve.

13. The electrochemical cell of claim 11, further comprising a temperature sensor, the temperature sensor in communication with the first valve and the second valve and configured to open at least one of the first valve or the second valve when a temperature inside the electrochemical cell exceeds a threshold value.

14. The electrochemical cell of claim 1, wherein the semi-solid electrode material further includes a conductive material.

15. An electrochemical cell module, comprising:
a first electrochemical cell;
a second electrochemical cell; and
a heat transfer fin disposed between the first electrochemical cell and the second electrochemical cell, the heat transfer fin including a plurality of bending strips and a plurality of strips of heat transfer material coupled to the plurality of bending strips,
wherein the plurality bending strips are in a first configuration at a first temperature such that at least a portion of the strips of heat transfer material contact the first electrochemical cell and the second electrochemical cell,
and wherein the plurality of bending strips are in a second configuration at a second temperature such that fewer strips of heat transfer material contact the first electrochemical cell and the second electrochemical cell than in the first configuration, the second temperature greater than the first temperature.

16. The electrochemical cell module of claim 15, wherein substantially no strips of heat transfer material contact the first electrochemical cell and the second electrochemical cell in the second configuration.

17. The electrochemical cell module of claim 15, wherein the plurality of bending strips are composed of at least one of tungsten, titanium, platinum, carbon steel, iron, steel, nickel, stainless steel, gold, copper, silver, brass, aluminum, or lead.

18. The electrochemical cell module of claim 15, wherein the heat transfer material is composed of at least one of copper, gold, silver, nickel, nickel titanium alloy, titanium, aluminum, steel, brass, iron, carbon steel, tungsten, platinum, or lead.

19. An electrochemical cell module, comprising:
a first electrochemical cell;
a second electrochemical cell; and
a heat transfer fin disposed between the first electrochemical cell and the second electrochemical cell, the heat transfer fin including a plurality of bending strips and sheets of insulative material disposed on either side of the bending strips adjacent to the first electrochemical cell and the second electrochemical cell,
wherein the plurality bending strips are in a first configuration at a first temperature such that the plurality of bending strips press the insulative material against exterior walls of the first electrochemical cell and the second electrochemical cell,
and wherein the plurality of bending strips are in a second configuration at a second temperature such that at least one of the sheets of insulative material does not contact an adjacent surface of the first electrochemical cell or the second electrochemical cell, the second temperature greater than the first temperature.

20. The electrochemical cell module of claim 19, wherein the plurality of bending strips are composed of at least one of tungsten, titanium, platinum, carbon steel, iron, steel, nickel, stainless steel, gold, copper, silver, brass, aluminum, or lead.
